(19) United States
(12) Patent Application Publication
(10) Pub. No.: US 2019/0236742 A1
(43) Pub. Date: Aug. 1, 2019

(54) METHOD FOR REQUESTING A RIDE SERVICE IN A RIDE SERVICE SYSTEM

(71) Applicant: INDRIVERRU, LTD, Nicosia (CY)

(72) Inventors: Arsen TOMSKII, Yakutsk (RU); Michil ANDROSOV, Yakutsk (RU); Aleksandr PAVLOV, Yakutsk (RU); Mikhail KHARBANOV, Yakutsk (RU); Alexander BURTSEV, Yakutsk (RU)

(21) Appl. No.: 15/881,811

(22) Filed: Jan. 29, 2018

(51) Int. Cl. G06Q 50/30; G06Q 30/06

(52) U.S. Cl. CPC G06Q 50/30; G06Q 30/0613; G06Q 30/0611

(57) ABSTRACT

A method, system and machine-readable medium for marching drivers with passengers and for saving money on long-distance rides on the basis of a passenger's price offer, bidding and bargaining, the method includes the following: enabling a passenger to create a ride request by means of a passenger interface, the ride request including a pickup location and a destination point; enabling the passenger to set a specified fare by means of the passenger interface after receiving the previously calculated average fare and the recommended fare data; and if the specified fare set by the passenger is lower than the previously set minimum price according to the pickup location and the destination point, then the ride request from the passenger is rejected and redirected to one or more third-party ride service systems.

### FIELD OF THE INVENTION

The present invention is directed to providing economical ride-sharing transportation services to potential customers, and more particularly to a method, system and machine-readable medium for matching drivers with passengers and for saving money on long-distance rides on the basis of a passenger's price offer, bidding and bargaining. The solution is based on three main principles: bidding and bargaining, focusing on long-rides only and low service fees for drivers.

### BACKGROUND

Usually an ordering cost is determined by a service itself. There is either a fixed price calculated according to a formula before traveling, or a meter charge at the end of traveling. In both cases, a passenger is either unaware of the cost calculating formula or the final traveling cost. The infeasibility for a passenger to influence the formation of pricing leads to unreasonably high costs for transportation services. This is especially true in a monopolized market or markets dominated by companies resorting to the cartel agreement.

The closest analogue of the claimed invention is a method, system and apparatus for providing transportation services described in the U.S. patent application No. US2006059023 (published on 16 Mar. 2006). Said system and method provides taxi patrons with a taxi-reservation system which facilitates better taxi service, better time utilization and financial rewards for taxi drivers who provide better service and more efficient pricing for buyers. The taxi-reservation system allows patrons to rate the taxi service they receive as well as pre-select taxi drivers from a pool of available taxi drivers. The system further enables taxi drivers to participate in a pricing scheme where customers can bid on proposed fares for their trips, and drivers, dispatchers or companies can bid on customers.

A disadvantage of the above mentioned solution can be considered to be the fact that there is no possibility to reject and redirect the ride request from a passenger with a too low price to one or more third-party ride service systems. According to our solution, the passengers are free to set a fare based on a fare recommended by the system, calculated as an average fare in other services minus a discount, but with a minimal level of an offering price. Drivers are free too, they could accept a passenger's offer, decline it or make own price offer (bargain), with a maximal level of an offering price. Also, our experience shows that a low service fee and a focus on long-distance rides (exclusion of short rides according to a price or distance minimum) are critically important for the whole scheme.

### SUMMARY OF THE INVENTION

According to the present invention, a method for requesting a ride service in a ride service system is provided, the method comprising the following steps: enabling a passenger to create a ride request by means of a passenger interface of the ride service system, the ride request including a pickup location and a destination point specified by the passenger; calculating, by means of the ride service system, an average fare and a recommended fare according to the pickup location and the destination point specified by the passenger to transmit the average fare and the recommended fare to the passenger; and setting, by means of the ride service system, a minimum price according to the pickup location and the destination point specified by the passenger to set it as a parameter in the ride service system; enabling the passenger to set a specified fare by means of the passenger interface of the ride service system after receiving the average fare and the recommended fare data; enabling the passenger to raise the specified fare by means of the passenger interface of the ride service system; receiving, by the ride service system, the specified fare set by the passenger; transmitting, by means of the ride service system, the ride request to driver's user devices; enabling a driver to place a bid in response to the ride request from the passenger and to specify an estimated arrival time (ETA) by means of a driver interface of the ride-service system; selecting, by means of the ride service system, a driver in response to the ride request from the passenger with the specified fare according to driver bids, driver device location and driver rating; providing, by means of the ride service system, driver selection results to the passenger and drivers, wherein if the specified fare set by the passenger is lower than the minimum price according to the pickup location and the destination point specified by the passenger, then the ride request from the passenger is rejected and redirected to one or more third-party ride service systems.

Furthermore, a ride service system is provided, comprising a processor, a machine-readable medium connected to the processor for communication. The machine-readable medium stores programmed instructions for requesting a ride service in the ride service system, upon execution of which by the processor, the method for requesting a ride service is implemented.

Moreover, the machine-readable medium, which stores programmed instructions for requesting a ride service, is provided, upon execution of which by the processor, the method for requesting a ride service in a ride service system is implemented.

### BRIEF DESCRIPTION OF THE DRAWINGS

FIG. 1 illustrates an example of the system for saving money on long-distance rides

FIG. 2 is a block diagram illustrating the lifetime of a passenger's ride request

FIG. 3 illustrates an example of the user interface with an order submission form

FIG. 4 illustrates an example of the user interface with the order submission form in awaiting fare calculation state

FIG. 5 illustrates an example of the user interface with the order submission form with the provided recommended fare and taxi services' average fare

FIG. 6 illustrates an example of the user interface with recommendations of other taxi services

FIG. 7 illustrates an example of the user interface with a recommendation to raise the fare

FIG. 8 illustrates an example of the user interface that is displayed to a passenger while searching for a driver

FIG. 9 illustrates an example of the user interface that is displayed to a driver with a nearby order notification

FIG. 10 illustrates an example of the user interface with driver bids that are displayed to the passenger

FIG. 11 illustrates an example of the user interface that is displayed to a passenger with a map of a driver's trip to the passenger.

### DESCRIPTION OF EXEMPLARY EMBODIMENTS

Embodiments described herein provide for a system and method for requesting a ride service and for saving money on long-distance rides on the basis of a passenger's price offer and bidding. As a passenger is free to set any fare for a ride, the system is able to provide a passenger with a recommended fare. Drivers may send offers with their fares and an estimated time of arrival to a passenger's ride request and a passenger may select any offer that is appropriate for him/her.

According to an embodiment, a passenger device can operate an application for requesting ride services. A user interface of the application provides a user with an ability to specify a pickup location and a destination point. If the pickup location and destination point coordinates are known, the system is able to calculate a fare and recommend it to the user. The user may change the fare and request a ride.

If the passenger's fare is lower than the minimum fare assigned to the location of the user, than the ride request can be declined. And if the passenger's fare is lower than the recommended minimum for the ride, then the passenger can be asked to raise the fare to the recommended minimum.

After the passenger places a ride request, drivers can place their bids on the request. They may be allowed to accept the ride request with the passenger's fare or to make it higher. The drivers are also able to specify an estimated arrival time, so the passenger can choose a suitable bid.

As described herein, a “passenger” or a “user” refers to individuals that are requesting or ordering an on-demand service. Also as described herein, a “driver” refers to individuals or entities that can provide the requested service. For example, a user can request an on-demand service (e.g., taxi service) using the system, and a service provider can communicate with the system and/or the user to arrange the service. In addition, as described herein, “user devices”, “passenger devices” and “driver devices” refer to computing devices that can correspond to cellular or smart phones, personal digital assistants (PDAs), tablet devices, etc., which can provide network connectivity and processing resources for enabling a user to communicate with the system over a network. A computing device can operate an application for requesting a ride. The application can provide user interface features that provide a user of the application with information for enabling the user to specify a fare.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from the context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more”, unless specified otherwise or clear from the context, to be directed to a singular form. The reference throughout this specification to “an embodiment” or “one embodiment” means that a particular feature, structure, or characteristic described in connection with the embodiment is included in at least one embodiment. Thus, the appearances of the phrase “an embodiment” or “one embodiment” in various places throughout this specification are not necessarily all referring to the same embodiment. Moreover, it is noted that the “n” notation used in reference to certain elements of the drawings is not intended to be limiting to a particular number of elements. Thus, “n” is to be construed as having one or more of the element present in a particular embodiment. It is to be understood that the above description is intended to be illustrative and not restrictive. Many other embodiments will be apparent to those of skill in the art upon reading and understanding the above description. The scope of the disclosure should, therefore, be determined with reference to the appended, claims, along with the full scope of equivalents to which such claims are entitled.

### System Description

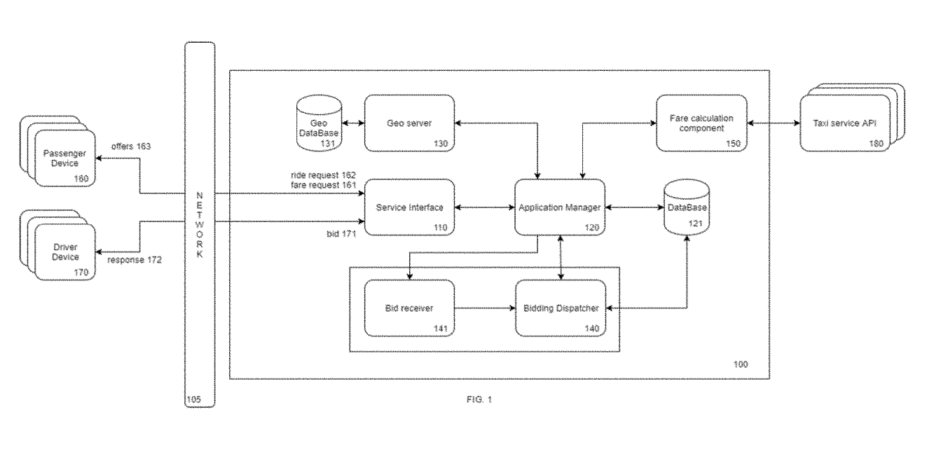

FIG. 1 illustrates an example pf a ride service system architecture. The system architecture includes a system 100, user devices (e.g. both passenger devices 160 and driver devices 170) and third-party service provider API. The user devices may be connected with the system 100 through a passenger interface and/or a driver interface. The system 100 may correspond to one or more user devices through a service interface. The system 100 may be connected with the taxi services' API 180. These components may be connected via a network 105, which is described in greater detail below.

The system 100 includes a service interface 110, an application manager 120, a bid receiver 141, a bidding dispatcher 140, a database 121, a geo server 130 with a geo database 131 and a fare calculation component 150. The components of the system 100 can be combined to enable a service for providing passengers with a recommended fare and matching passengers (users who operate on passenger devices 160) with drivers (users who operate on driver devices 170).

A bundle of the passenger interface, the driver interface and the service interface 110 provides communications between the system 105 and user devices (e.g. passenger devices 160 and driver devices 170) over the network 105. Each of the passenger devices 16 can download, store and operate an application that can interact with the service interface 110 through the passenger interface in order to provide information to and/or receive information from the service interface 110. Similarly, drivers can operate their driver devices 170 to download, store and operate the same application that also can interact with the service interface 110 through the driver interface.

The service interface 110 can receive a pickup location and a destination point from one or more passenger devices 160 over the network. For example, data can be received from a user device when a user launches or operates the application (or performs other actions in the application). Depending on embodiments, die application manager 120 translates data to the geo server 130 to get coordinates of the points and processes the data to request information on fares in the third-party services through the fare calculation component 150. The fare calculation component 150 may request date on fares through third-party service API if available. In some embodiments, fares may be calculated without third-party services by a fare formula. After receiving data on fares, the fare calculation component 150 can calculate an average fare. After the calculations the application manager 120 can provide it to the end-user through the chain of the service interface 110 and the user interface over the network 105.

The passenger is provided with the average fare of the trip, he/she is still able to change the fare and request a ride. Depending on embodiments, the ride request data can include data indicating a gps location of the passenger device, user ID data, a fare set by the passenger and ride request details (e.g. a pickup location, destination and additional information).

The service interface 110 receives the ride request, handles the data, processes the data to translate it to the application manager 120. Because the service interface 110 can receive a large amount of data from the user devices (e.g. passenger devices 160 and driver devices 170), the application manager 120 handles and organizes the ride request data for storage in one or more databases 121. For example, the data can be deleted, categorized into tables, etc. so that the components of the system can easily access the data from the databases 121 to retrieve necessary information. The application manager 120 also translates the list of the ride requests to the driver devices 170 via the service manager.

The bid dispatcher 140 may also provide drivers with fares higher than passenger's ones by 10%, 20% and 30%, but these fares may not be higher than an average fare of third-party services.

In some embodiments, driver requests can include data indicating a GPS location of the driver device, his/her bid, an estimated time of arrival, user ID data and a ride request ID which a driver has selected. When the data is received over the network, the service interface can provide the received driver request to the request receiver.

The service interface 110 receives driver request data, handles the data, processes the data to translate it to the bid receiver. The bid receiver component can collect driver requests.

The bidding dispatcher 140 handles driver requests with its bids 171 and saves an order ID, a bid price, an ETA and driver request time-stamp to the database 121. Each driver request has its own timeout. During this timeout the bidding dispatcher 140 waits for a passenger response for the bid 171. The passenger may accept the bid 371, decline or ignore it. The bidding dispatcher 140 can then provide driver selection results to the service interface 110 and the application manager 120. The bidding dispatcher 140 can transmit the driver selection result to the driver devices 170 over the network 105. The bidding dispatcher 120 can also provide the selected driver data to the passenger devices 160, so that the passenger can be notified about the arrangement. If the bid 171 is accepted, the bidding dispatcher 140 sends an accept response 172 to the driver device 170. If it is declined or ignored. She driver receives a decline response 172. An accepted driver can be assigned for the order, while other drivers can be informed that the order is taken through the service interface 110. The application manager 120 handles and organizes the provided data for storage in one or more databases 121.

The network 105 may include a public network (e.g., the Internet), a private network, (e.g., a local area network (LAN) or a wide area network (WAN)), a wired network: (e.g., Ethernet network), a wireless network (e.g., an 802.11 network or a Wi-Fi network), a cellular network (e.g., a Long Term Evolution; (LTE) network), routers, hubs, switches, server computers, and/or a combination thereof.

### Method Description

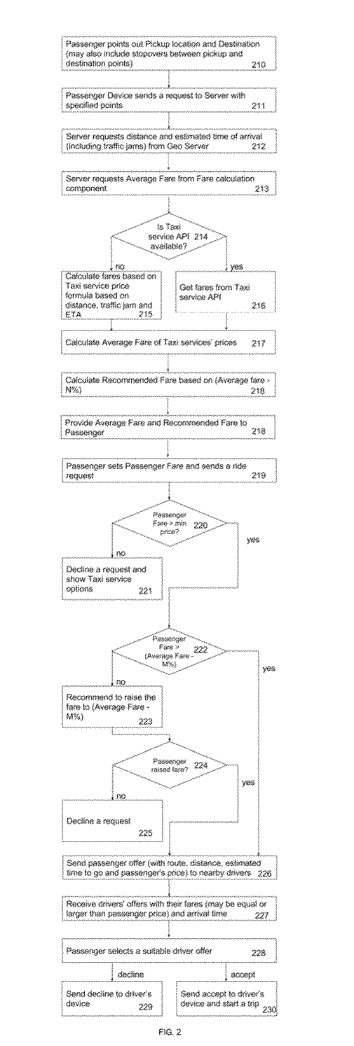

FIG. 2 illustrates an example of the method for requesting a ride service in a ride service system and for matching drivers with passengers based on received data, according to an embodiment. A method described here can be implemented using components described in the description of the system on FIG. 1.

The application manager 120 receives a pickup location and a destination point from the passenger device 160. In some embodiments, there also could be stopover points. The application manager 120 translates the received points to the geo server 130 to retrieve the coordinates of the points, the distance of the trip and the estimated time of arrival. In some embodiments, the geo server 130 can include a traffic jam situation and apply it to the estimated time of arrival.

With the data received from the geo server 130, the application manager 120 can request fare information from the fare calculation component 150. In some variations, the fare calculation component 150 can request a fare from third-party service's API. if it is not available, a fare calculation can be done based on a taxi service price formula, which is based on distance, traffic jams and an ETA.

When fares are calculated, the fare calculation component 150 can calculate the average fare and the recommended fare of the ride. The recommended fare can be calculated based on the average fare and some percentage (n %), which can be set on server as a parameter. So the recommended fare equals the average fare minus n %. These calculated values can be translated to the passenger device 160. In some cases, a passenger is still able to change the recommended fare and set his own fare.

After a passenger sends a ride request, the system 100 may compare the passenger's set fare and the minimum price. The minimum price can be set on the server as a parameter for the passenger's location. If the passenger's fare is less than the minimum price, the ride request can be declined according to an embodiment. In some variations, the system may recommend to use other services, which are available.

If the passenger's specified fare is more than the minimum price, the system may compare it with the minimum, recommended fare, which can be calculated as the average fare minus some M %. M percentage can be also set as a parameter. If the passenger's fare is less than the minimum recommended fare, the system may request a user to raise the passenger's specified fare to the minimum recommended fare.

If the passenger's specified fare equals or is more than the minimum recommended fare, the system sends the ride request to nearby drivers. Drivers may offer their bids 171, which include an offered fare, driver's car information, a driver's rating and an estimated time of arrival. In some embodiments, a driver's fare can be equal or larger than the passenger's specified fare. According to an embodiment, a passenger is free to choose any driver's offer and decline other bids.

### User Interface Description

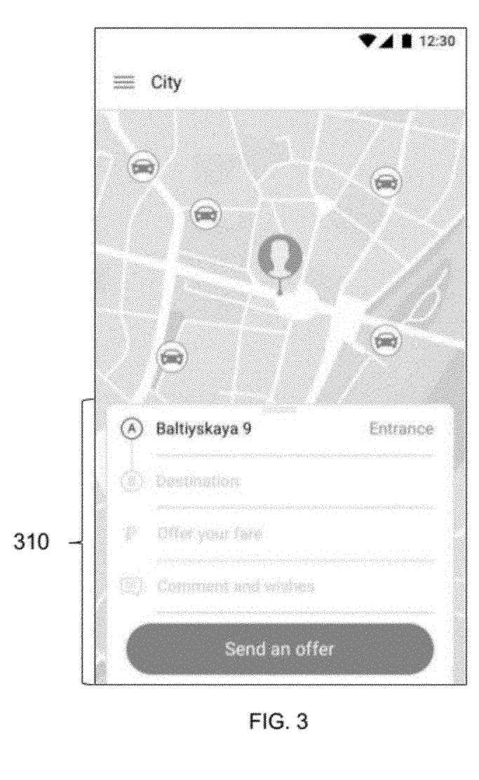

FIG. 3 illustrates an example of the user interface with an order submission form that is displayed to a passenger who requests a ride. The user interface illustrates a user interface that can be provided by an application running on a user device. Such an application can be provided by an entity that enables a service to be arranged between drivers and passengers and also allows specifying a fare of the ride. For example, a user can download and Install the application on his/her device and register the device with the system. The user can also create an account to be able to request services (e.g. provide a user name, a date of birth, etc.). The stored application can enable data to be exchanged between the application and the system so that the user can interact with the system.

When a user launches the application and operates the service application, a variety of different user interfaces can be provided on the display of the device depending on different stages or steps during the ride request process. For example, the service application can first display a sign in a user interface where a user must first enter his/her phone number in order to log in to the application and to be able to interact with the system. After signing in, the application can display a user interface that illustrates an order submission form 310.

The order submission form 310 can consist of inputs of a pickup location, a destination location, a fare, additional information for a driver. Depending on embodiments, when a user interacts with the form 310, the form 310 can be expanded so that the user can specify multiple stopovers and/or request additional options such as a need in a child seat and/or a mini van. A fare for the ride can be set by a passenger, e.g., a passenger can decide how much money he/she can spend on the ride. By submitting the order submission form, the user can request a ride. Then the application transmits the ride request to the system for processing.

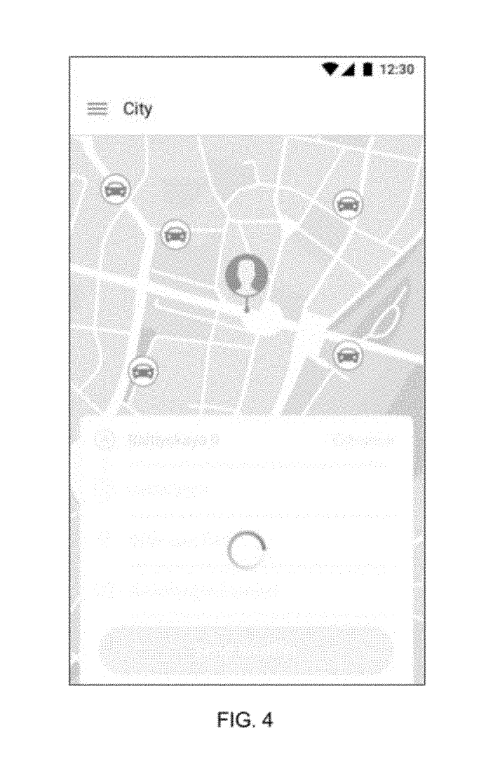

FIG. 4 illustrates an example of the user interface in the state awaiting for a recommended fare of the order form. The user can specify a pickup location and a destination point. After that the application sends a request to get the recommended fare for the ride. While the application waits for a response, the order form freezes and shows an awaiting indicator.

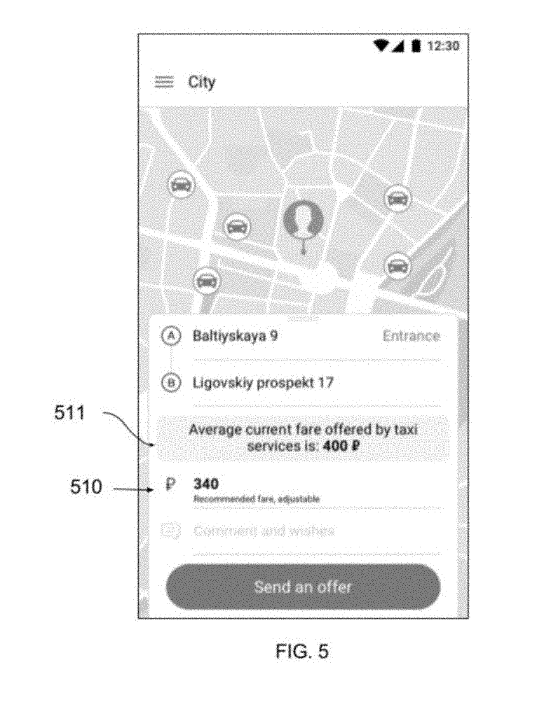

FIG. 5 illustrates an example of the user interface when the system provided the recommended fare 510. In this example the recommended fare can be set in the fare input and the average fare 511 is shown above this input. A user is free to change the fare to any value he/she wants.

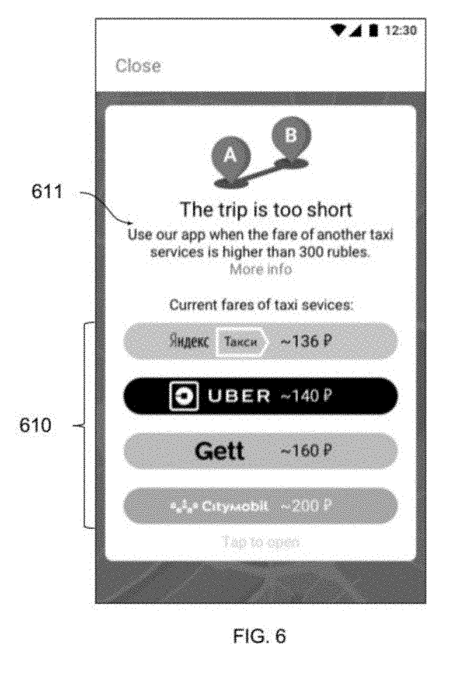

FIG. 6 illustrates an example of the user interface that is displayed to a passenger that attempts to request a ride for a fare that is lower than the minimum fare for this location. In this example of an embodiment, a passenger is provided with an explanatory text 611 and current fares 610 of other taxi services. A passenger can select any other service provider and the application will transmit him/her to the third-party service application. The close button is also available to close this state and return to the order form.

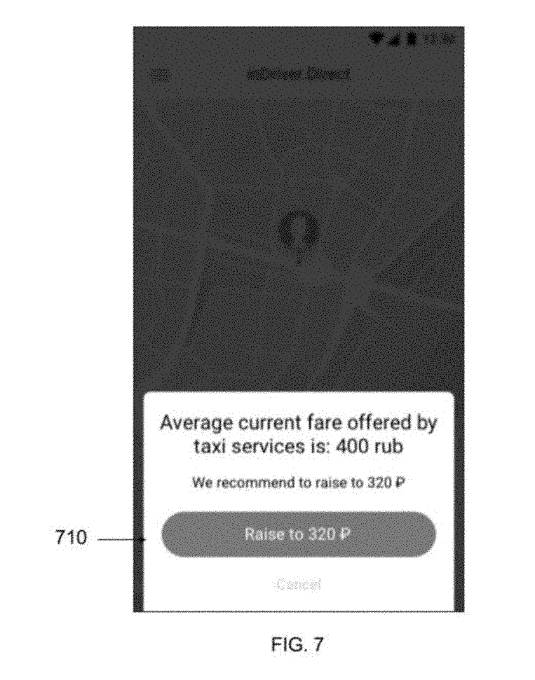

FIG. 7 illustrates an example of the user interface that is displayed to the passenger when the passenger specifies a fare that is lower than the minimum recommended fare. The user interface in the state can include an explanatory text and a button 710 to raise the fare to the recommended minimum. The user is also able to cancel the ride request and return to the order form.

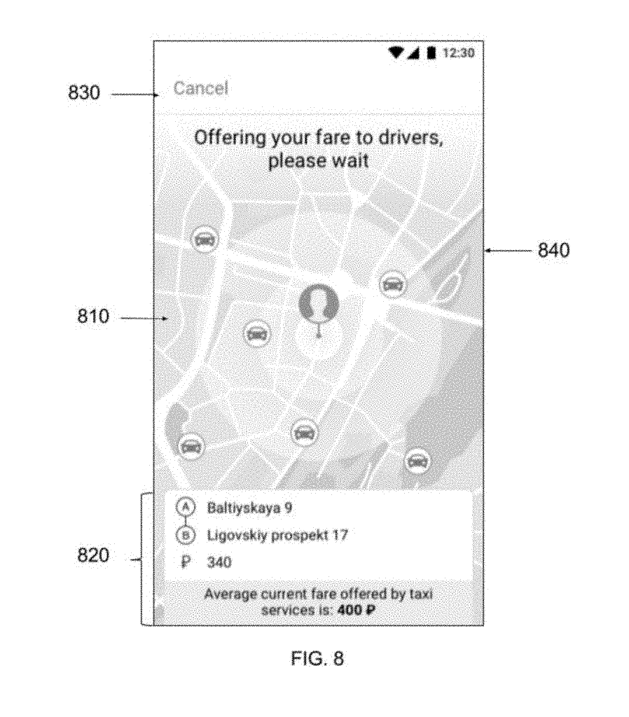

FIG. 8 illustrates an example of the user interface 840 that is displayed to the passenger while searching for a driver after the passenger submits the order. The passenger device provides a change in the interface to the searching for a driver state.

The user interface in state can include a map 810 with a radar symbolizing a driver searching process and ride request data 820 provided by the passenger. The cancel button 830 is also available for the passenger to cancel the searching.

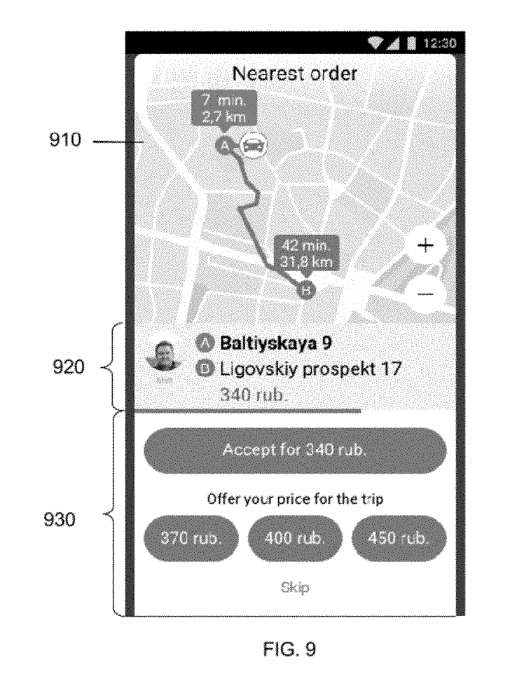

FIG. 9 illustrates as example of the user interface that is displayed to the driver when a notification about nearby order is received. The user interface in state can include a map 910 with a pickup location and a destination pointed on the map, a route with an estimated time of arrival to the pickup point and from the pickup point to the destination point.

The ride request data 920 and 930 is also shown under the map. Driver is able to accept a passenger's fare or bid higher. The skip button is available to skip this order.

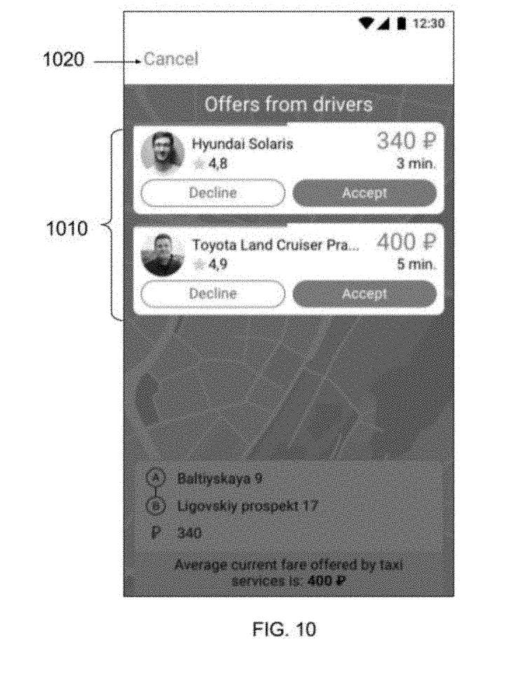

FIG. 10 illustrates an example of the user interface that is displayed to the passenger with drivers' bids. Drivers' bids 1010 may include car information, a driver's fare, a driver's rating and an estimated time of arrival. A passenger is free to accept any bid or decline it. The cancel button 1020 is also available to cancel the ride request and return to the order form.

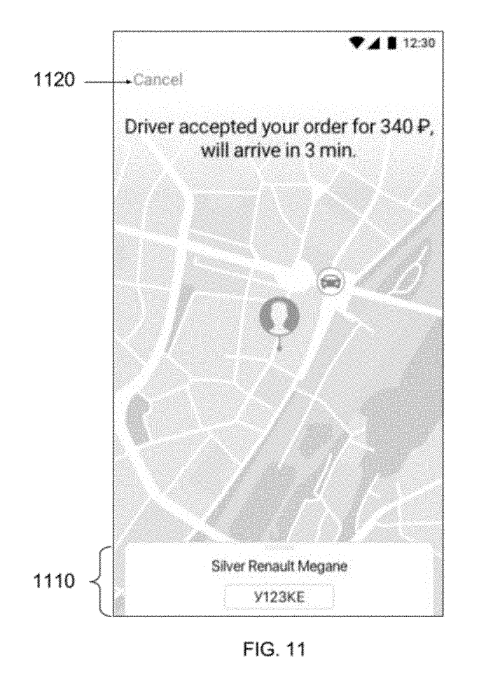

FIG. 11 illustrates an example of the user interface that is displayed to the passenger when the driver is assigned for the order. When the assigned driver is determined, the application can provide a transition in the user interface from one state to another state. The user interface can provide information 1110 about the assigned driver to help the passenger to identify the driver. The cancel button 1120 is also available to cancel the ride request and return to the order form.

It should be understood that the above-described embodiments are described by the way of example only. The scope of the present invention should not be limited by any of the above-described embodiments but should be defined only in accordance with the appended claims.

1. A method for requesting a ride service in a ride service system, comprising:
enabling a passenger to create a ride request by means of a passenger interface of the ride service system, the ride request including a pickup location and a destination point specified by the passenger;
calculating, by means of the ride service system, an average fare and a recommended fare according to the pickup location and the destination point specified by the passenger to transmit the average fare and the recommended fare to the passenger; and
setting, by means of the ride service system, a minimum price according to the pickup location and the destination point specified by the passenger to set it as a parameter in the ride service system;
enabling the passenger to set a specified fare by means of the passenger interface of the ride service system after receiving the average fare and the recommended fare data;
enabling the passenger to raise the specified fare by means of the passenger interface of the ride service system;
receiving, by the ride service system, the specified fare set by the passenger;
transmitting, by means of the ride service system, the ride request to driver's user devices;
enabling a driver to place a bid in response to the ride request from the passenger and to specify an estimated arrival time by means of a driver interface of the ride service system;
selecting, by means of the ride service system, a driver in response to the ride request from the passenger with the specified fare according to driver bids, driver device location and driver rating;
providing, by means of the ride service system, driver selection results to the passenger and drivers;
wherein
if the specified fare set by the passenger is lower than the minimum price according to the pickup location and the destination point specified by the passenger, then the ride request from the passenger is rejected and redirected to one or more third-party ride service systems.

2. The method of claim 1, wherein the recommended fare equals the average fare minus n %, where n % is set as a parameter in the ride service system.

3. A ride service system comprising:
one or more processors,
a machine-readable medium connected to the at least one processor and comprising programmed instructions for requesting a ride service, which, upon their execution by the at least one processor, implement a method comprising the following steps:
enabling a passenger to create a ride request by means of a passenger interface of the ride service system, the ride request including a pickup location and a destination point specified by the passenger;
calculating, by means of the ride service system, an average fare and a recommended fare according to the pickup location and the destination point specified by the passenger to transmit the average fare and the recommended fare to the passenger; and
setting, by means of the ride service system, a minimum price according to the pickup location and the destination point specified by the passenger to set it as a parameter in the ride service system;
enabling the passenger to set a specified fare by means of the passenger interface of the ride service system after receiving the average fare and the recommended fare data;
enabling the passenger to raise the specified fare toy means of a passenger interface of the ride service system;
receiving, by the ride service system, the specified fare set by the passenger;
transmitting, by means of the ride service system, the ride request to driver's user devices;
enabling a driver to place a bid in response to the ride request from the passenger and specifying an estimated arrival time by means of a driver interface of the ride service system;
selecting, by means of the ride service system, a driver in response to the ride request from the passenger with the specified fare according to driver bids, a driver device location and a driver rating;
providing, by means of the ride service system, driver selection results to the passenger and drivers;
wherein
if the specified fare set by the passenger is lower than the minimum price according to the pickup location and the destination point specified by the passenger, then the ride request from the passenger is rejected and redirected to one or more third-party ride service systems.

4. The system of claim 3, wherein the recommended fare equals the average fare minus n %, where n % is set as a parameter in the ride service system.

5. A machine-readable medium, comprising:
programmed instructions for requesting a ride service, which, upon their execution by at least one processor, implement a method comprising the following steps:
enabling a passenger to create a ride request by means of a passenger interface of the ride service system, the ride request including a pickup location and a destination point specified by the passenger;
calculating, by means of the ride service system, an average fare and a recommended fare according to the pickup location and the destination point specified by the passenger to transmit the average fare and the recommended fare to the passenger; and
setting, by means of the ride service system, a minimum price according to the pickup location and the destination point specified by the passenger to set it as a parameter in the ride service system;
enabling the passenger to set a specified fare by means of the passenger interface of the ride service system after receiving the average fare and the recommended fare data;
enabling the passenger to raise the specified fare by means of the passenger interface of the ride service system;
receiving, by the ride service system, the specified fare set by the passenger;
transmitting, by means of the ride service system, the ride request to driver's user devices;
enabling a driver to place a bid in response to the ride request from the passenger and to specify an estimated arrival time by means of a driver interface of the ride service system;
selecting, by means of the ride service system, a driver in response to the ride request from the passenger with the specified fare according to driver bids, a driver device location and a driver rating;
providing, by means of the ride service system, driver selection results to the passenger and drivers;
wherein
if the specified fare set by the passenger is lower than the minimum, price according to the pickup location and the destination point specified by the passenger, then the ride request from the passenger is rejected and redirected to one or more third-party ride service systems.

6. The machine-readable medium of claim 5, wherein the recommended fare equals the average fare minus n %, where n % is set as a parameter in the ride service system.
